(19) United States
(12) Patent Application Publication
(10) Pub. No.: US 2022/0107102 A1
(43) Pub. Date: Apr. 7, 2022

(54) AIR CONDITIONING DEVICE

(71) Applicant: OAIRO ALLIANCE LIMITED, Bourne End (GB)

(72) Inventor: Bryan Saxby, Bourne End (GB)

(21) Appl. No.: 17/428,862

(22) PCT Filed: Feb. 5, 2020
(86) PCT No.: PCT/GB2020/050265

§ 371 Date: Aug. 5, 2021

(30) Foreign Application Priority Data
Feb. 5, 2019 (GB) 1901601.3

(51) Int. Cl. F24F 11/00; F24F 11/65

(52) U.S. Cl. CPC F24F 11/0001; F24F 2110/10; F24F 11/65

(57) ABSTRACT

There is provided a system for controllably altering properties of a body of air comprising: at least one sensor for detecting properties of bodies of air; an air extraction unit for extracting quantities of air from a region containing air; an air provision unit for providing quantities of air to the region; and, a controller configured to: receive at least one indication of air temperature from the at least one sensor; calculate a first quantity of air to extract from the region and a second quantity of air to provide to the region based on an intended temperature change for the region, wherein the calculation is based on an indication of air temperature of air in the region from the sensor and properties of the second quantity of air; control the air extraction unit to extract the first quantity of air from the region; and, control the air provision unit to provide the second quantity of air from the region.

### FIELD

The present application is generally related to an air control device, and is particularly but not exclusively related to a device for controllably altering properties of a body of air.

### BACKGROUND

Air conditioning and climate control are prevalent in the modern world. Control over the environment in which humans spend time is important to ensure that comfort and air quality levels are maintained during what can be long periods indoors (for example in business buildings) or during uncomfortable seasons (e.g. hot summers or cold winters).

Conventional air conditioning and climate control may involve the introduction of cooler air into a room of warmer air, or vice versa. The introduced air dissipates via convection and fan power to affect the bulk air properties in the room. This air is often recycled from the room with no air quality controls. Such systems have drawbacks. Such systems rely on convection currents to circulate and mix up the air in an attempt to create a uniform temperature and air mix. However, known systems may produce draughts due to the introduction of air to the room. Known systems may also produce hot/cold spots within the room due to the required force of air to combat stratification and possibly the arrangement and control of the systems.

### SUMMARY

Particular aspects and embodiments are set out in the appended claims.

According to a first aspect of this disclosure, there is provided a system for controllably altering properties of a body of air comprising: at least one sensor for detecting properties of bodies of air; an air extraction unit for extracting quantities of air from a region containing air; an air provision unit for providing quantities of air to the region; and, a controller configured to: receive at least one indication of air temperature from the at least one sensor; calculate a first quantity of air to extract from the region and a second quantity of air to provide to the region based on an intended temperature change for the region, wherein the calculation is based on an indication of air temperature of air in the region from the sensor and properties of the second quantity of air; control the air extraction unit to extract the first quantity of air from the region; and, control the air provision unit to provide the second quantity of air from the region.

In an embodiment, the at least one sensor is arranged to detect at least one property of the second quantity of air, the controller is configured to receive an indication of the at least one property of the second quantity of air from at least one sensor, and the at least one property of the second quantity of air comprises at least one of pressure, temperature and volume.

In an embodiment, the calculation of the first quantity of air to extract and the second quantity of air to provide is performed based on a physical relationship between temperature and pressure represented by the equation:

PV=nRT,

wherein P represents pressure, V represents volume, n represents number of moles, R represents ideal gas constant and T represents absolute temperature.

In an embodiment, the at least one sensor for detecting properties of bodies of air is arranged to detect properties of bodies of air internal to and external to the device.

In an embodiment, the second quantity of air provided to the region has properties to enable stochastic interaction of the air in the second volume with the second body of air.

In an embodiment, the second quantity of air has a greater pressure than the air in the region. In an embodiment, the quantities of air are bulk quantities of air.

In an embodiment, the at least one sensor is for detecting a plurality of: temperature; pressure; CO2 levels; humidity; allergens; toxins; and, pollutants.

According to a second aspect of this disclosure, there is provided a method for controllably altering properties of a body of air comprising: detecting an indication of air temperature by a sensor; receiving by a controller the indication of air temperature; calculating a first quantity of air to extract from a region containing air and a second quantity of air to provide to the region based on an intended temperature change for the region wherein the calculation is based on the indication of air temperature; extracting a first quantity of air from the region; and, providing a second quantity of air to the region.

In an embodiment, detecting an indication of air temperature by a sensor comprises detecting an indication of air temperature of air contained in the region, the method further comprising: detecting at least one property of the second quantity of air; and, receiving by a controller the at least one property of the second quantity of air; wherein the at least one property of the second quantity of air comprises at least one of pressure, temperature and volume.

In an embodiment, the calculation of the first quantity of air to extract and the second quantity of air to provide is performed based on a physical relationship between temperature and pressure represented by the equation:

PV=nRT,

wherein P represents pressure, V represents volume, n represents number of moles, R represents ideal gas constant and T represents absolute temperature.

In an embodiment, the method further comprises detecting properties of bodies of air internal to and external to the device.

In an embodiment, detecting properties of bodies of air comprises detecting any of the following of bodies of air: temperature; pressure; CO2 levels; humidity; allergens; toxins; and, pollutants.

In an embodiment, the extracting step and the providing step are distinct.

In an embodiment, the extracting step occurs prior to the providing step.

In an embodiment, the method further comprises repeating the detecting, extracting, predicting and introducing steps.

### BRIEF DESCRIPTION OF THE DRAWINGS

Specific embodiments will be described below by way of example only and with reference to the accompanying drawings, in which:

FIG. 1 shows a schematic sectional view of an air control device in accordance with a first example;

FIG. 2 shows a schematic sectional view of an air control device in situ in accordance with a second example; and

FIG. 3 shows a graph of temperature of air against time during operation of the device of FIG. 2.

### DETAILED DESCRIPTION

In this specification, “air control” is used to refer to the control of bulk properties of air by a device which can be controlled by a user. These properties include temperature among others. Control may be related to increasing or decreasing the temperature of the air, and though examples described herein may state only, e.g., cooling air, it is to be understood that the same principles may be applied to produce heated air.

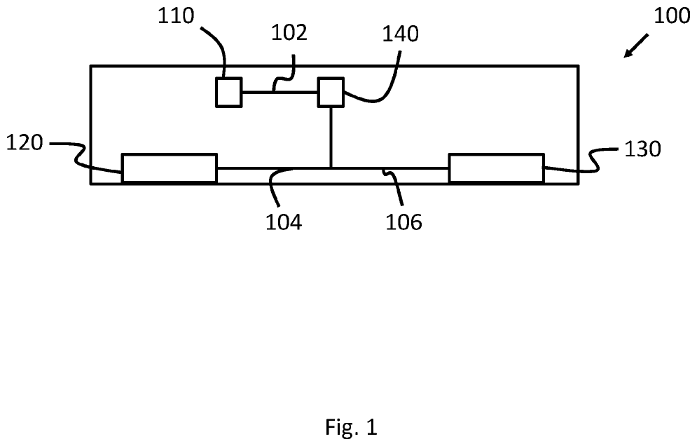

FIG. 1 shows a schematic sectional view of a first example of a system 100. The term “device” and “system” may be used interchangeably throughout. The device 100 is a device for controllably altering properties of a body of air. The device 100 has at least one sensor 110 for detecting properties of bodies of air. The device 100 also has an air extraction unit 120 for extracting quantities of air from a region containing air. The device 100 also has an air provision unit 130 for providing quantities of air to a region. The device 100 also has a controller 140 configured to receive at least one indication of air temperature from the at least one sensor 110; calculate a first quantity of air to extract from a region and a second quantity of air to provide to a region based on an intended temperature change for a region, wherein the calculation is based on an indication of air temperature of air in a region from the at least one sensor and properties of the second quantity of air; control the air extraction unit 120 to extract the first quantity of air from a region; and, control the air provision unit 130 to provide the second quantity of air from a region.

As shown in the example of FIG. 1, the sensor 110 (only one is shown in the example of FIG. 1) is connected to the controller 140 by feed 102. The sensor 110 may send information to the controller 140 with which the controller 140 may perform calculations or take further action. The controller 140 is also connected to the air extraction unit 120 by feed 104. The controller 140 may send commands to the air extraction unit 120 along feed 104 as a result of information received from the sensor 110. The controller 140 is also connected to the air provision unit 130 by feed 106. The controller 140 may send commands to the air provision unit 130 along feed 106 as a result of information received from the sensor 110 and/or as a result of commands sent to the air extraction unit 120 along feed 104. The controller 140 is for calculating, predicting and delivering the exact volume of air/gas (molecules) at a precise thermal energy level.

The air extraction unit 120 and air provision unit 130 may have air supply properties and mechanical properties that may be controlled by the controller 140. In examples, the humidity, temperature and flow speeds of air supply alongside the fan speeds may be fed to the controller 140 to enable high levels of control over the properties of the air introduced by the air provision unit 130. Such measurements on air extracted by the air extraction unit 120 allow the controller 140 to assess the condition of air in the room in which the device 100 is located. The air extraction unit 120 and air provision unit 130 may have dampers for an additional level of control over the operation of the units 120, 130. Such dampers will be discussed in more detail below.

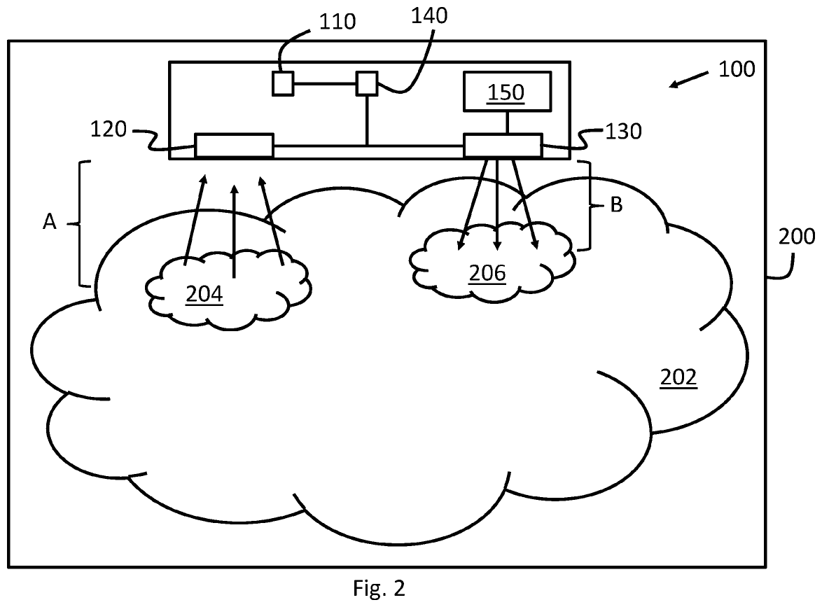

FIG. 2 shows a schematic sectional view of a device 100 in situ in accordance with a second example. In particular, the device 100 is positioned within a room or region 200. The region 200 may be a zone or a space, which may or may not be within a room. The region 200 contains air 202 illustrated as a cloud (though of course this is only illustrative; air would fill the volume of the region). During an example operation of the device 100, the sensor 110 detects that the air 202 in the region 200 is at a certain temperature (e.g. 26 degrees). The device 100 has a temperature set point, which is a desired target temperature for the air 202 in the region 200 to achieve (e.g. 18 degrees). The air 202 in the region 200 is above this set point. The sensor 110 sends this information to the controller 140. The controller 140 then instructs the air extraction unit 120 to extract a first quantity of air from the region 200. This first quantity is some portion of the air 202 that is present in the region 200 at the start point. The arrows labelled A indicate the action of extraction of a first quantity 204 of air from the air 202 in the region 200. The controller 140 then instructs the air provision unit 130 to provide a second quantity of air to the region 200. The arrows labelled B indicate the action of provision of a second quantity 206 of air to the region 200.

The controller 140 controls the amount of air 204 removed from, and air 206 added to, the air 202 in the region 200 as well as many other properties. The properties that are significant in the calculations performed by the controller 140 include the temperature of the air 202 in the region 200 and the temperature of the air in the air supply 150 from which the air provision unit 130 provides air. The device 100 may have an internal or external air supply 150, which may be integral with the air provision unit 130. In the example shown in FIG. 2, the device 100 has an internal air supply 150.

The controller 140 may also receive indications of the pressure, air velocity, air density alongside properties such as CO2 levels, humidity, allergens, toxins, and, pollutants. The controller 140 may receive indications of such properties from an air handling unit or from external sensors (external to the device 100) or the like located in the room in which the device 100 is located. In this way the controller 140 may react to changing environmental conditions and adjust the supply of air 206 so as to maintain or obtain desirable air properties. Other properties that may be provided to the controller 140 include independent supply and extract fan speeds, fresh air damper percentage, recirculation damper percentage, exhaust air damper percentage and current work load percentage. Set points may be set for any of these properties as well as temperature. These may be set (or altered) prior to or during operation of the device 100.

So as to maintain or obtain these properties, the controller 140 may be supplied by programming or via user interaction an indication of the desired properties. For example, the indication of the desired properties may be a set point temperature or a humidity level above which the air 202 in the region 200 should be prevented from reaching. Once the sensor 110 or a series of sensors 110 detects that a property of the air 202 needs to be altered, the controller 140 may perform calculations so as to effectively affect the air 202 in the region 200 to adjust that property. This enables the present device 100 to analyse, react, compute solutions and command the components to allow full control over the air 202 in the region 200, based on real-time sensory information received by the controller 140.

The location of the sensor or sensors 110 within the region 200 may be arranged to avoid undesirable effects resulting from the walls of the region 200 (in the event that the region 200 has walls). Where the region 200 has external walls, the external walls may be affected by the temperature of the air on the external facing side of the wall. This may lead to sensors located near the walls providing readings not related to properties of the well-mixed air within the region 200. As such, unreliable sensor readings can be avoided by placement of the sensors 110 not near the walls of the region 200. This in turn leads to more accurate air-property detection by the sensors 110, and therefore more efficient operation by the device 100. In the present device 100, location of the sensors 110 greater than 20 mm from walls in the region 200 leads to the advantages noted above being achieved. In an example, the sensors 110 may be located anywhere from 20 mm from the walls to the centre of the region 200.

In an example, information obtained on the air 202 in the region 200, air 204 removed from the region 200 and air in the air supply 150 and air outside the region (e.g. outdoors) is utilised by the controller 140 to calculate optimal delivery conditions for the air 206. These calculations may occur on the scale of about every 15 seconds to ensure the device 100 provides resilient, reactive and effective control over the properties of the air 202 in the region 200.

The calculations performed by the controller 140 utilise kinetic molecular theory alongside gas law principles to calculate properties of the air 202 in the region 200. Having obtained the conditions of the air 202 in the region 200, the controller 140 calculates the properties of the air 206 to be delivered to the region 200 to obtain desirable conditions of the air 202 in the region 200. In particular this includes the temperature of the air 206. Alongside the temperature of the air 206, the pressure and mass of the air 206 may be controlled to ensure effective alteration of the properties of the air 202 in the region 200.

The controller 140 may receive indications of properties of air and repeat calculations during operation and accordingly deliver different masses of air 206, or masses of air 206 with different properties, to the region 200. For example, as the temperature of the air 202 in the region 200 approaches the set point temperature, a lower mass of air 206 may be supplied by the air provision unit 130. This ensures that, for example, the temperature of the air 202 in the region 200 is not dropped considerably beyond the set temperature, prior to a rectification to focus onto the set point temperature. By avoiding this, the device 100 avoids wasting energy when approaching the set temperature. This results in a highly efficient device 100 for controlling properties of bodies of air.

In an example, the air 206 provided to the region 200 has a greater pressure than the air 202 in the region 200. As the air 206 expands into the region 200, due to the difference in pressures, the molecular velocity and number of stochastic collisions is increased over the introduction of air 206 at the same pressure of the air 202 in the region 200. A result is stochastic molecular motion with lower and/or fewer intermolecular forces. In an example, the air 206 provided to the region 200 has a difference in energy to the air 202 in the region 200. As the air 206 expands into the region 200, due to the difference in energy levels, the molecular velocity and number of stochastic collisions is increased as compared to the introduction of air 206 at the same energy as the air 202 in the region 200. A result is stochastic molecular motion with lower and/or fewer intermolecular forces. Greater mixing efficiency than found using modern air conditioning systems is achieved as a result of these high velocity molecular collisions. This has an impact on reduction of draughts caused by the device 100 when supplying air 206 to the region 200, as large amounts of airflow are not required. This also has an impact on the stratification within the region 200 as a result of highly efficient mixing of provided air 206 with the air 202 in the region 200. Air stratification is significantly reduced, in use, by the present device 100.

The expansion of the air 206 into the air 200 is calculated by the controller 140 based on gas laws and kinetic molecular theory. Accordingly, the precise return volume (the volume of air extracted by the air extraction unit 120) is calculated and controlled.

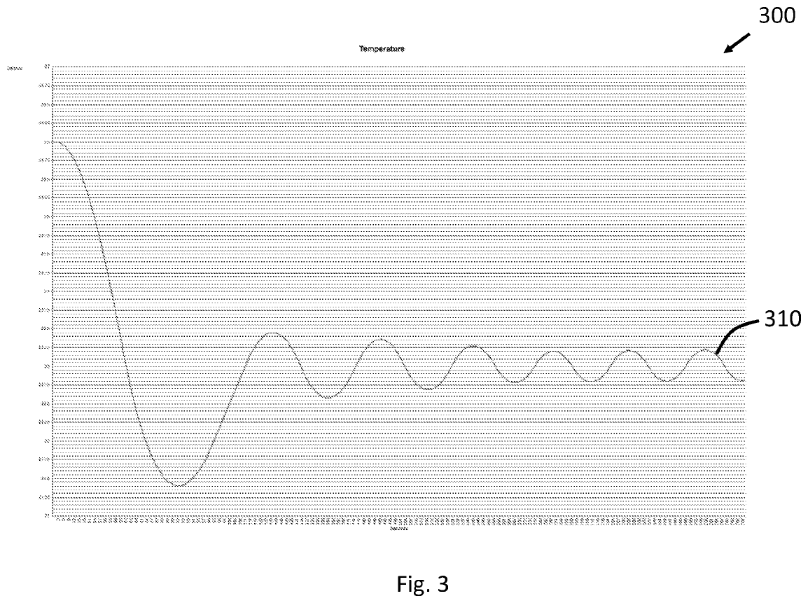

FIG. 3 shows a graph 300 of temperature in degrees Celsius plotted against time, which is equivalent to the iteration of calculations and delivery of air 206 from the air provision unit 130. The curve 310 shown clearly shows that the device 100 results in the temperature of the air 202 in the region 200 accurately approaching the set point temperature, with minimal overshoot (going past the set point temperature), and being maintained around the set point temperature. The live calculations of the controller 140 of the device 100 lead to the control of all system components in 1% increments. This may include compressors, dampers, air handling units, a return fan which is located before a mixing damper, and other components within the system 100. This fine control far outstrips conventional systems some of which operate at 25% component increments. Clearly, a far improved user experience is provided with this present system 100. This leads directly to a large increase in human wellbeing as a result of a finely tunable environment with filtered/purified air.

The device 100 allows gaseous molecules to dissociate into their constituent elements (Nitrogen 78%, Oxygen 21%, trace gases—Argon, Carbon Dioxide, Neon, Helium, Krypton). This ensures a stochastic and rapid movement with high collision ratios causing rapid energy transfer. This naturally eliminates humidity over 61.2%. As such, highly effective humidity control is provided by the present system 100.

The present system 100, creates synchronicity across the system components, repeating the detecting, extracting, predicting and introducing steps of air and thermal or kinetic energy to create the circumstances for molecular acceleration, high collision ratios and maximum energy transfer producing a uniform environment. This is provided by the feedback loops of detection and calculation as sensors feed information, as described above, to the controller 140 for the controller 140 to manipulate subsequent iterations of the operation of the system 100.

The device 100 may have an integral power source or be connected to an external power source. The sensor 110 and the controller 140 may require electrical power to function.

Modern systems have dampers which are known as valves or plates that stop or regulate the flow of air inside air-handling equipment. Dampers can therefore be used to cut off or hinder delivery of air from device 100. This can be achieved by altering the position of the dampers so as to prevent airflow. In an example the device 100 has dampers for providing additional control over airflow. The device 100 may have a supply damper and an extract damper to provide additional control to the supply of air to the region 200 and the extraction of air from the region 200. The controller 140 controls the damping provided by the dampers of the air extraction unit 120 and air provision unit 130. The dampers may be operated at 1% increments to provide high level sensitivity and high levels of control over the provision/extraction of air. This assists in providing a highly uniform environment in the room in which the device 100 is operating. Indeed, with the present device 100 near zero stratification of air is achievable.

During a cooling operation, the device 100 may operate as follows: if the temperature of air 202 in the region 200 is higher than the temperature set point, the device 100 calculates the mass of air 204 to be extracted from the region 200, then calculates the mass of air 206 to be supplied to the region 200, including molecular expansion as a result of the relative gas properties including pressure, temperature and energy. The controller 140 then calculates the effect that the supply step and extraction step will have on the region 200. If the predicted temperature is within the deadband zone around the set point (+/−0.5° C.) then the supply and extract dampers located in the air provision unit 130 and the air extraction unit 120 respectively are held in their current positions, but if the predicted temperature of the air 202 in the region 200 is still higher than the temperature set point, the controller 140 increases the position of the supply and extract dampers (independently). Otherwise if the predicted temperature of the air 202 in the region 200 is below the temperature set point then the position of the supply and extract dampers is decreased (independently). The calculations then start again. The set point of the present device 100 has a sensitivity of +/−0.5° C. which is far greater than the accuracy available from modern air conditioning systems, which typically have an accuracy of +/−2 to 3° C. The deadband is used herein to refer to the region around the set point at which one makes no changes.

The calculations performed by the controller 140 during operation of the device 100 may be substantially as follows:

Step 1: Calculate the number density of air in the region 200 using the equation:

$$\frac{{n}_{r}}{{V}_{r}} = \frac{{p}_{r}}{R {T}_{r}}$$

where nᵣ is the number of molecules of air in the region 200, Vr is the volume of the region 200, nᵣ/Vᵣ is the number density of air in the region 200, pᵣ is the pressure in the region 200, R is the gas constant, and Tᵣ is the temperature in the region 200.

Step 2: Calculate the number density of air at the supply temperature and pressure using the equation:

$$\frac{{n}_{s}}{{V}_{s}} = \frac{{p}_{s}}{R {T}_{s}}$$

where symbols have the same meaning as in step 1 but with the subscripts indicating that the quantity relates to the supply air from the air provision unit 130.

Step 3: Calculate the number density of air at the extract temperature and pressure using the equation:

$$\frac{{n}_{e}}{{V}_{e}} = \frac{{p}_{e}}{R {T}_{e}}$$

where symbols have the same meaning as in step 1 but with subscripts indicating that the quantity relates to extract air to the air extraction unit 120.

Step 4: Calculate the expansion factor between supply air and air in the region 200 according to:

$$E = \frac{{n}_{s} / {V}_{s}}{{n}_{r} / {V}_{r}}$$

where E is the expansion factor.

Step 5: Calculate the current energy associated with the region 200 using the equation:

Uᵣ=cVᵣTᵣ

where Uᵣ is the current energy associated with the region 200 and c is the heat capacity of air per unit volume.

Step 6: Calculate the energy of supply air to be supplied in the next 15 seconds using:

Uₛ=cvₛTₛdₛ*15 secs

where Uₛ is the energy of supply air to be supplied in the next 15 seconds, vₛ is the rate at which supply air is being supplied to the region 200, and dₛ is the supply damper percentage.

Step 7: Calculate the energy of the extract air to be extracted in the next 15 seconds using:

Uₑ=cvₑTₑdₑ*15 secs

where symbols have the same meaning as in step 6 but with subscripts indicating that the quantity relates to extract air.

Step 8: Calculate the predicted energy in the region 200 after the next 15 seconds using:

U_{pred}=Uᵣ+Uₛ−Uₑ

where U_{pred} is the predicted energy in the region 200 after the next 15 seconds.

Step 9: Calculate the predicted temperature in the region after the next 15 seconds from the predicted energy using:

$${T}_{pred} = \frac{{U}_{pred}}{c {V}_{r}}$$

where T_{pred} is the predicted temperature in the region after the next 15 seconds.

Step 10: Compare the predicted temperature to the set point to determine whether to adjust the supply and extract dampers:
if T_{pred} is within the deadband region of the set point, make no change to the dampers;
if the system is in cooling mode:
   if T_{pred} is less than the set point, decrease the supply damper by 2%;
   otherwise if T_{pred} is greater than the set point, increase the supply damper by 2%;
otherwise if the system is in heating mode:
   if T_{pred} is greater than the set point, decrease the supply damper by 2%;
   if T_{pred} is less than the set point, increase the supply damper by 2%.

Step 11: If the supply damper has been adjusted then adjust the extract damper to allow for the amount of supply air and the amount of expansion expected according to:

dₑ=Edₛ

In other examples, such as when even finer control is desired, the predicted energy and temperature in the region 200 are calculated for after less than the next 15 seconds. Thus, the predicted energy and temperature may be calculated after between the next 5 seconds and 15 seconds. The time period between calculations may vary, for example, in one iteration, the delay may be 5 seconds and, in the next iteration, the delay may be 10 seconds and, in the next iteration, the delay may be 15 seconds. Any sequence of delays may be selected based on environmental conditions. If the sensors detect rapidly changing environmental conditions, a shorter delay may be advantageous. Alternatively, the predicted energy and temperature in the region can be calculated for after more than the next 15 seconds, such as for after 15 to 25 seconds. This may be when the environmental conditions are not changing so significantly. This may assist in prolonging the lifetime of the device 100, as mechanical changes are not demanded so regularly.

In a similar manner, and for similar advantageous reasons, the dampers may be controlled by more or less than 2%. This level of control may be varied according to environmental conditions to allow the device 100 to operate in an optimised manner. For example, the damper may be adjusted by greater than 2% should the air in the region require greater levels of introduced air to achieve the desired condition of air, whether temperature, toxicity, humidity etc. For example the damper may be adjusted by 3%, 4%, 5%, 6%, 7%, 8%, 9%, 10% etc. Similarly, the damper may be adjusted less, if environmental conditions need limited changing to achieve desired conditions. In an example, the damper may be adjusted by 1% or less than 1%.

When a supply or extract damper opens, this causes a drop in the pressure in the respective duct, which will then cause the controller 140 to modify the system to maintain the required pressure.

During a heating operation, the above procedure for cooling is altered in the relationship between the temperature and the set point. The remaining steps are the same. Specifically, the temperature of the air 202 in the region 200 is below the temperature set point.

During a purification operation, such as for removal of CO₂ from air 202 in the region 200, the device 100 supplies fresh air to the region 200. In an example, an extra 5% fresh air is added every 15 seconds. The temperature of the air 202 in the region 200 may be monitored and varied to prevent over cooling/heating. If the temperature continues to pass the temperature set point by more than one degree Celsius, the device 100 will not open the dampers further and an alarm condition may be enabled. A user may then be alerted by the alarm and may investigate the reason behind the detection of high CO₂ (pollutant) level.

As discussed above, the present device 100 may be operated faster than every 15 seconds, however a balance can be made between faster calculation times, and thus delivery of air times, and the overall lifetime of the device 100. Faster operation of the device 100 may lead to a decrease in the operational lifetime of the components of the device 100. As such, the lifetime of the device 100 is balanced against speed of delivery of air in the presently disclosed example device 100, resulting in calculations being made every 15 seconds.

The device 100 may also operate to provide a fresh air purge. This would involve purging the air 202 in the region 200 and replacing with air 206 with desired properties, such as low humidity and low CO₂ (pollutant) values. This may be advantageous in environments with low air quality, such as in buildings during high occupancy and the like.

The combination of the features in the device 100 enables a significant energy saving over conventional systems. The techniques described herein reduce workload on the components of the device 100 and as a result, energy savings of up to 90% are available.

Further advantages of the presently described device 100 may include high energy efficiency which may lead to a reduction in the mechanical requirements demanded of the device 100. This in turn can lead to an increased lifetime of the device 100. The introduction of high pressure air 206 into the region 200 may lead to high molecular movement of the introduced air 206. In examples, there are resulting high levels of elastic collisions between the air 202 in the region 200 and the introduced air 206. Molecular velocity may be increased between the introduced air 206 and the air 202 in the region 200. A resulting effect may be almost zero stratification as the introduced air 206 mixes quickly and thoroughly with the air 202 in the region 200. Therefore, the device 100 can provide highly effective and highly efficient air mixing. Indeed, greater levels of mixing have been found in the present device 100 than for modern systems. In particular, air mixing in relation to the distance from walls in the region 200 in which the device 100 is operated has been found as close as 20 mm from the wall. Typical systems do not provide this level of mixing proximate to walls in the region 200.

The device 100 described herein has a number of advantages over conventional systems. Current directed airflow systems require 6 to 10 times more air input to achieve the recommended air mixing and quality in the region, as a result of poor molecular efficiency and stratification. This often results in hot and cold areas rather than one homogenous temperature and also can create draughts with localised pockets of pollutants. Instead, the device 100 described herein requires vastly less mechanical air movement due to efficient molecular activity which results in greater mixing and movement of the provided air and the air already present in the region. Stratification of less than 1 or 2° C. has been found for a floor to ceiling height of over 14 metres.

1. A system for controllably altering properties of a body of air comprising:
at least one sensor for detecting properties of bodies of air;
an air extraction unit for extracting quantities of air from a region containing air;
an air provision unit for providing quantities of air to the region; and
a controller configured to:
receive at least one indication of air temperature from the at least one sensor;
calculate a first quantity of air to extract from the region and a second quantity of air to provide to the region based on an intended temperature change for the region, wherein the calculation is based on an indication of air temperature of air in the region from the sensor and properties of the second quantity of air;
control the air extraction unit to extract the first quantity of air from the region; and
control the air provision unit to provide the second quantity of air from the region.

2. The system according to claim 1,
wherein at least one sensor is arranged to detect at least one property of the second quantity of air,
wherein the controller is configured to receive an indication of the at least one property of the second quantity of air from at least one sensor, and
wherein at least one property of the second quantity of air comprises at least one of pressure, temperature and volume.

3. The system according to claim 1, wherein
the calculation of the first quantity of air to extract and the second quantity of air to provide is performed based on a physical relationship between temperature and pressure represented by the equation:
PV=nRT,
wherein P represents pressure, V represents volume, n represents number of moles, R represents ideal gas constant and T represents absolute temperature.

4. The system of claim 1, wherein at least one sensor for detecting properties of bodies of air is arranged to detect properties of bodies of air internal to and external to the device.

5. The system of claim 1, wherein the second quantity of air provided to the region has properties to enable stochastic interaction of the air in the second volume with the second body of air.

6. The system of claim 1, wherein the second quantity of air has a greater pressure than the air in the region.

7. The system of claim 1, wherein the quantities of air are bulk quantities of air.

8. The system of claim 1, wherein the at least one sensor is for detecting a plurality of:
temperature;
pressure;
CO2 levels;
humidity;
allergens;
toxins; and,
pollutants.

9. The method for controllably altering properties of a body of air comprising:
detecting an indication of air temperature by a sensor;
receiving by a controller the indication of air temperature;
calculating a first quantity of air to extract from a region containing air and a second quantity of air to provide to the region based on an intended temperature change for the region wherein the calculation is based on the indication of air temperature;
extracting a first quantity of air from the region; and
providing a second quantity of air to the region.

10. The method of claim 9, wherein detecting an indication of air temperature by a sensor comprises detecting an indication of air temperature of air contained in the region, the method further comprising:
detecting at least one property of the second quantity of air; and
receiving by a controller the at least one property of the second quantity of air,
wherein the at least one property of the second quantity of air comprises at least one of pressure, temperature and volume.

11. The method of claim 9, wherein the calculation of the first quantity of air to extract and the second quantity of air to provide is performed based on a physical relationship between temperature and pressure represented by the equation:
PV=nRT;
wherein P represents pressure, V represents volume, n represents number of moles, R represents ideal gas constant and T represents absolute temperature.

12. The method of claim 9, further comprising detecting properties of bodies of air internal to and external to the device.

13. The method of claim 12, wherein the detecting properties of bodies of air comprises detecting any of the following of bodies of air:
temperature;
pressure;
CO2 levels;
humidity;
allergens;
toxins; and
pollutants.

14. The method of claim 9, wherein the extracting step and the providing step are distinct.

15. The method of claim 9, wherein the extracting step occurs prior to the introducing step.

16. The method of claim 9, wherein the method further comprises repeating the detecting, extracting, predicting and introducing steps.
